(19) United States
(12) Patent Application Publication
(10) Pub. No.: US 2006/0277748 A1
(43) Pub. Date: Dec. 14, 2006

(54) Method of mounting electro-conductive rings on a non-conductive tubular body

(75) Inventor: Khai Si Luong, Fountain Valley, CA (US)

Correspondence Address: KHAI SI LUONG, 17514 SAN BAYAS ST., FOUNTAIN VALLEY, CA, 92708, US

(73) Assignee: ALPINE BIOMED CORP.

(21) Appl. No.: 11/146,979

(22) Filed: Jun. 8, 2005

(51) Int. Cl. H01F 7/06

(52) U.S. Cl. 29/606; 29/868

(57) ABSTRACT

An inexpensive method to build thin-wall, flush-mounted, electro-conductive rings directly from the conductor leads embedded inside a non-conductive tubular body is described. Such rings, made from a combination of mechanical and chemical processes, are intended for use as cylindrical electrodes when placed inside human tubular organs.

### BACKGROUND OF THE INVENTION

Cylindrical electrodes are known to have the best shape for applications inside human tubular organs such as the artery, the esophagus, the intestine, or the urethra. To mount such electrodes on a tubular plastic body, current methods use rings cut from extruded metallic tubing (Sramek, U.S. Pat. No. 4,836,214), shaped from metallic strips (Silny et al., U.S. Pat. No. 5,109,870.), or made of cylindrical conductive fabric (Wood, U.S. Pat. No. 4,852,580.) In order for the rings be able to record biological events or to deliver electrical stimulation inside a patient organ, they need to be connected to corresponding diagnostic or therapeutic devices via signal leads embedded inside of the tubular body.

There a several techniques to attach the ring to the signal lead, such as soldering, welding, crimping or bonding, and all of such techniques face the same challenges described below:
1. Attachment made on the outside wall of the ring is straight forward, but will modify the shape of the ring, compromise the integrity of its sensing surface, and interfere with its performance.
2. Attachment made on the inside wall of the ring is very difficult, given the small diameter of the ring. Also, such a joint will significantly reduce the inside diameter of the ring and interfere with the process of sliding the ring onto a tubular body. To circumvent the problem, either the ring has to be made larger than desired, with enough room underneath for the attachment junction, or the tubular body has to be cut into two pieces and bonded back together on either side of the ring, after the attachment is done.
   FIG. 1, FIG. 1A and FIG. 1B show one of the conventional methods for mounting a ring 1 onto a tubular body 2. In this method, ring 1 is first connected to conductor lead 3 by means of contact junction 4, then slip on top of tubular body 2. As can be seen from the drawings, the gap between ring 1 and tubular body 2 provides room for junction 4, but also prevents the ring from being flush-mounted.
   FIG. 2, FIG. 2A and FIG. 2B show another conventional method for mounting a ring. In this cut-and-bond technique, tubular body 2 is cut into two pieces. After ring 1 has been connected to conductor lead 3 via attachment junction 4, the two cut pieces of tubular body 2 are joined back together at both ends of the ring. This cut-and-bond method adds the cost of machining to the cost of the ring and compromises the integrity of the tubular body. With the risk of the weak points 5 breaking open during operation, unwanted substance can leak to the inside of the tubing, react with the material of the junction and interfere with the ring performance. Furthermore, any attachment made underneath the ring in the cut-and-bond method will either plug up, or at best reduce substantially the lumen inside of the tubing. In many applications, these lumen need to be preserved to house more signal leads or to transport fluid in and out of the tubular organs.
3. Attachment made on the edge of the ring is not practical or feasible, since rings of these types of application usually have very thin wall in the range of a few tenths of a millimeter.
4. Any junction material used to attach the rings to the signal leads must be conductive in nature. In many applications where body fluids are involved, such a material reacts with the environment and interferes with the performance of the rings. Because those junctions are too close to the exposed surface of the rings, they are vulnerable to short leak paths. Sealing them off completely is a very difficult task and production yield could be significantly affected.

### BRIEF SUMMARY OF THE INVENTION

The invention is about an inexpensive and reliable technique for mounting a single or plurality of electro-conductive rings onto the periphery of a tubular body. Such tubular body is made with non-conductive material and can have a circular or elliptical cross-section. When placed inside a patient's tubular organ, the electro-conductive rings are referred to as cylindrical, circular, circumferential or annular electrodes. The technique combines the processes of winding, bonding, filing and electroplating, to produce a solid, thin wall, flush mounted, electro-conductive ring directly from a signal conducting lead. Rings fabricated with such a technique can be from 1 mm to several centimeters in length, with walls as thin as 0.2 mm. They can also be nearly flush-mounted on a tubular body with an outer diameter as small as 1 mm. Because the rings are fabricated directly from the signal leads, they require no additional attachment such as bonding, crimping, welding or soldering, to be electrically connected.

### BRIEF DESCRIPTION OF THE SEVERAL VIEWS OF THE DRAWING

FIG. 1 is a perspective view of one of the conventional method to mount the ring, with the large diameter of the ring substantially larger than that of the tubular body.

FIG. 1A is a view along the axis of the tubular body of FIG. 1, showing the space required for the attachment junction.

FIG. 1B is a section view of FIG. 1A.

FIG. 2 is a perspective view of another conventional method to mount the ring, called the cut-and-bond method.

FIG. 2A is a view along the axis of the tubular body of FIG. 2.

FIG. 2B is a section view of FIG. 2A.

FIG. 3 shows the first step of the proposed technique to mount a ring on a long tubular body.

FIG. 3A shows the first step of the proposed technique to mount more than one ring on a long tubular body.

FIG. 4 shows the second step of the proposed technique with the conductor lead wrapped around of the tubular body into a coil shape.

FIG. 4A is a view looking down the axis of the tubular body of FIG. 4.

FIG. 4B is a section view of FIG. 4A.

FIG. 5 shows the third step of the technique with epoxy applied to secure both ends of the coil.

FIG. 6 shows the coil after its outer surface has been shaved off.

FIG. 7 shows the layer of plated material built on top of the coil in FIG. 6, with a spiral pattern of shallow troughs on the surface.

FIG. 8 shows more epoxy applied to give a smooth profile to the ring.

FIG. 9 shows the final shape of the fabricated ring, after the shallow troughs with excess plated material and epoxy are removed.

FIG. 9A is a view looking down the axis of the tubular body of FIG. 9.

FIG. 9B is a section of view of FIG. 9A.

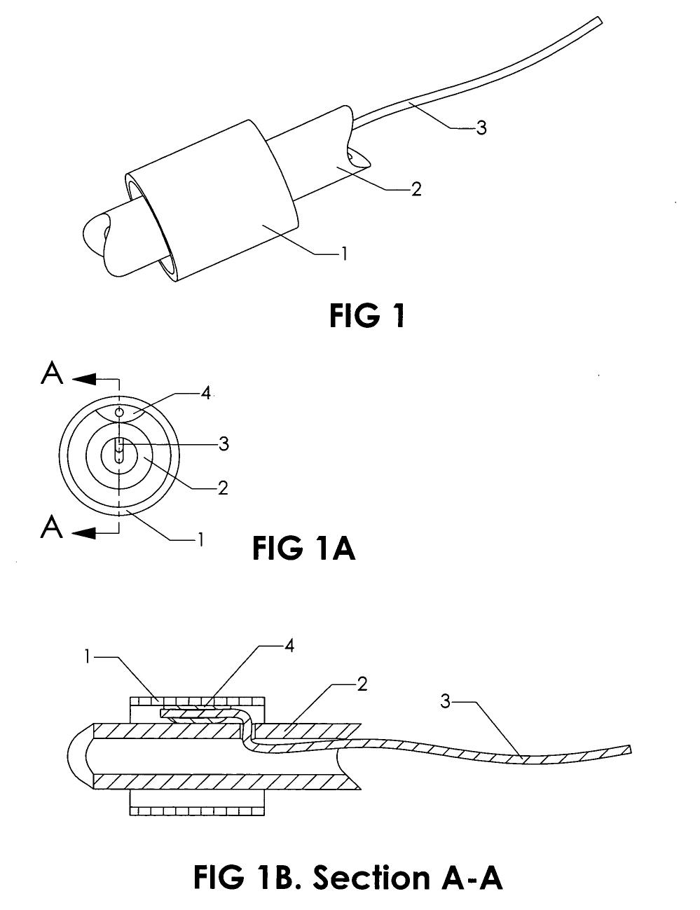

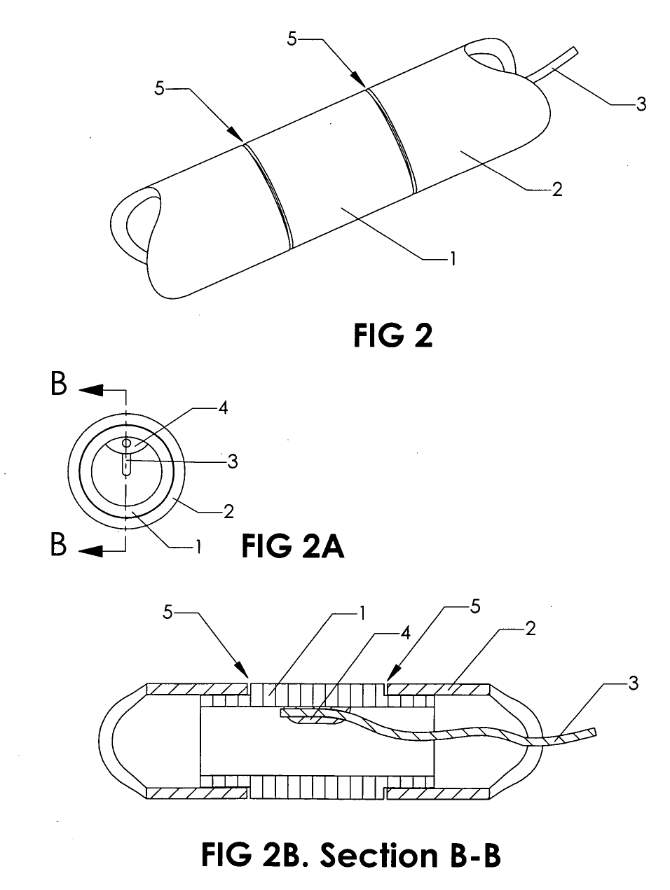

### DETAILED DESCRIPTION OF THE INVENTION

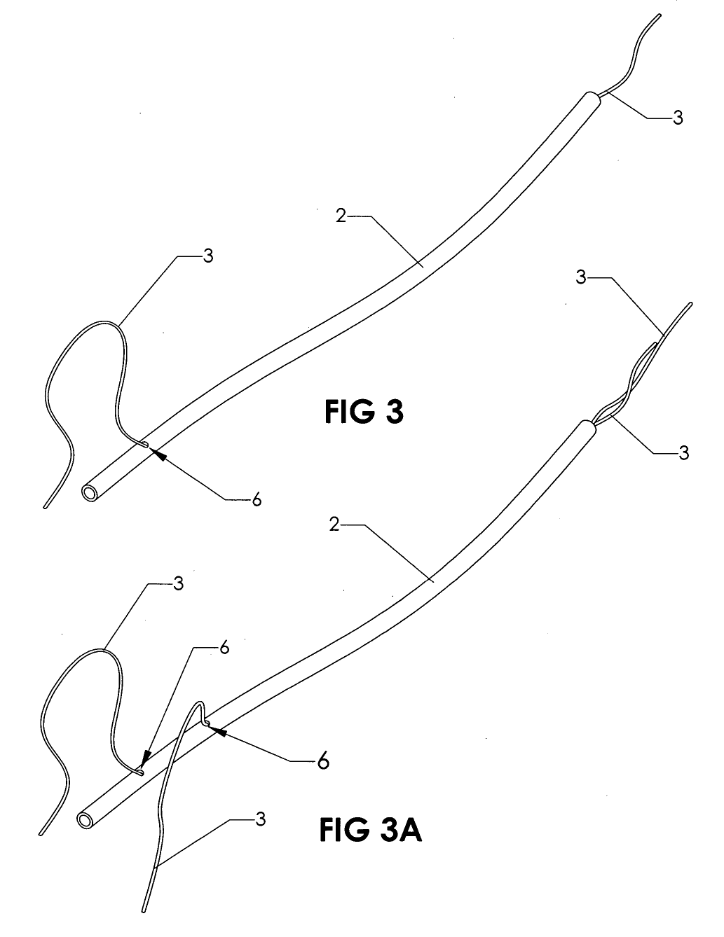

1. FIG. 3 shows the first step of the proposed method with a conductor lead 3 having one end coming out of the wall of a tubular body 2, through a pre-drilled side hole 6. The length of the protruding portion of the conductor lead is suggested to be about 30 cm.

2. FIG. 3A shows an example of a multiple-ring configuration with two conductor leads 3 coming of the wall a tubular body 2 through two side holes 6.
The material of the tubular body 2 can be any type of flexible plastic that would adhere to epoxy, such as Polyvinylchloride or Polyurethane. The diameter of the tubing is chosen to fit inside of the tubular organ it is intended for. While only one lumen is shown in this drawing, it is quite possible to have a tubular body with a plurality of lumen for other purposes than just housing the conductor leads.
The position of the side hole 6 along the length of the tubular body is where the ring will eventually be located. The side hole can be created by any conventional method such as drilling, punching or clipping, or by even more advanced techniques such as laser ablation.
The conductor lead 3 is a single-stranded copper wire of dimension ranging from 0.1 mm to 1 mm in diameter. It is recommended to choose a conductor size about the desired wall-thickness of the intended ring. It is important to note that while copper is primarily referred to in this disclosure, any soft-temper metal that is commercially available such as brass, tin, nickel-copper alloy, silver or gold can also be used as conductor lead.
While the conductor lead 3 can be a bare wire, it is strongly recommended to use a conductor lead that is pre-coated with conventional insulation material such as polyurethane or polyimide, generally called magnet wire. The advantage is several conductor leads with insulation coating can share the same lumen without short-circuiting. Furthermore, rings made eventually from conductor leads with insulation coating do not require to be tightly sealed from leaks as rings made from conductor leads without insulation coating.

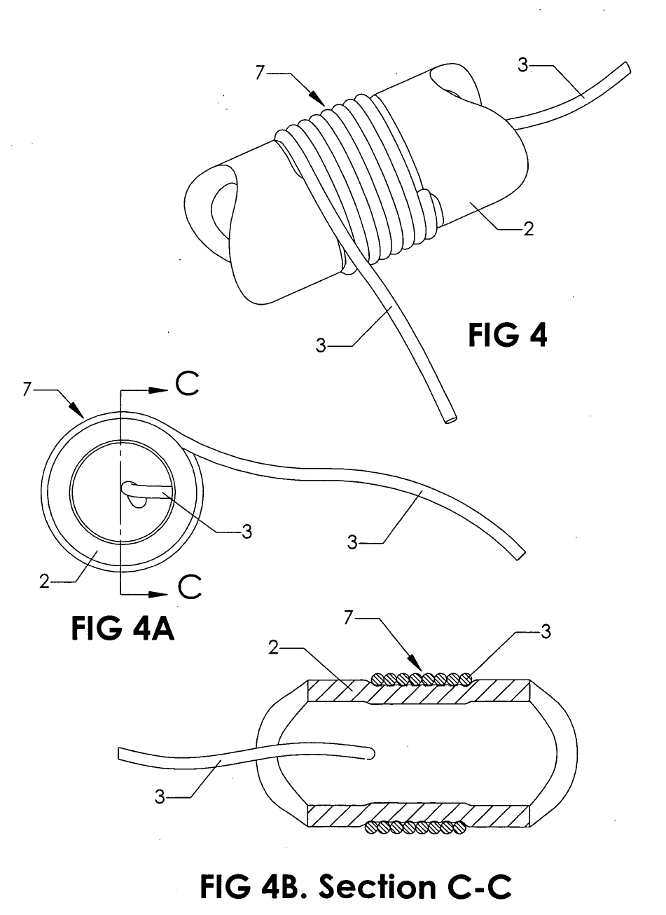

3. FIG. 4 shows a short portion of the tubular body 2 about the location of side hole 6 of FIG. 3. In this figure, the protruding portion of the conductor lead 3 is wrapped around the periphery of the tubular body into a coil 7 made of a series of tightly packed windings. The number of windings approximates the length of the intended ring and the excess of conductor lead will be trimmed off later on. For a ring to be nearly flush-mounted, tension will be added during the winding to sink the conductor lead below the surface of the tubular body.

4. FIG. 4A shows the inside of the tubular body 2, looking in the direction of its longitudinal axis. In this view, conductor lead 3 comes out of the side hole and wraps tightly around periphery of the tubular tubing 2, making a coil 7 of tightly packed windings.

5. FIG. 4B is a cross-sectional view of the assembly, revealing the effect of tension on the tubular body 2 by the windings of coil 7, made from conductor lead 3.

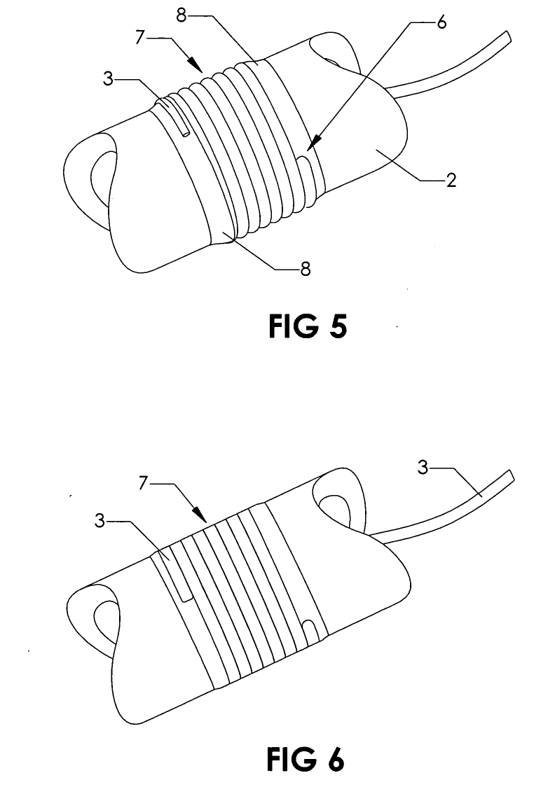

6. FIG. 5 shows both ends of the coil 7 being secured in place on the tubular body 2 with two bands of epoxy 8 all around the edges. It also shows the excess portion of conductor lead 3 trimmed off. When securing the coil with epoxy, make sure that the side hole 6 is sealed off at the same time. Any type of epoxy can be used in this step, but a photo curable epoxy is highly recommended to speed up the curing process.

7. FIG. 6 shows the outer surface of the coil 7 shaved off to level down the helical pattern of bumps on the surface the windings from FIG. 5. This step is essential because it narrows the gaps between the windings, making it easier for electrodeposited material (in the next step) to bridge across. This step is also needed to expose the conducting material if insulated conductor lead is being used. Shaving off the outer surface of the coil can be done with any conventional mechanical method of sanding, filing, grinding, polishing, or any combination thereof, to remove material for the purpose of leveling the bumps patterns on the outside wall of the coil. If processing the coils in batch is desired, wet chemical etching or anodic stripping can be used. Because there are so many etching or stripping techniques available, with each technique depending upon the choice of material for the conductor leads, it is beyond the scope of this disclosure to discuss them in details here. When performing the material removal step, whether using mechanical or chemical means, avoid reducing the diameter of the portion of conductor lead 3 that made up coil 7 by more than ½ of its original size. Because of the geometric arrangement, any reduction of the conductor lead in the coil by more than ½ of its original diameter will have the adverse effect of widening the gaps between the windings.

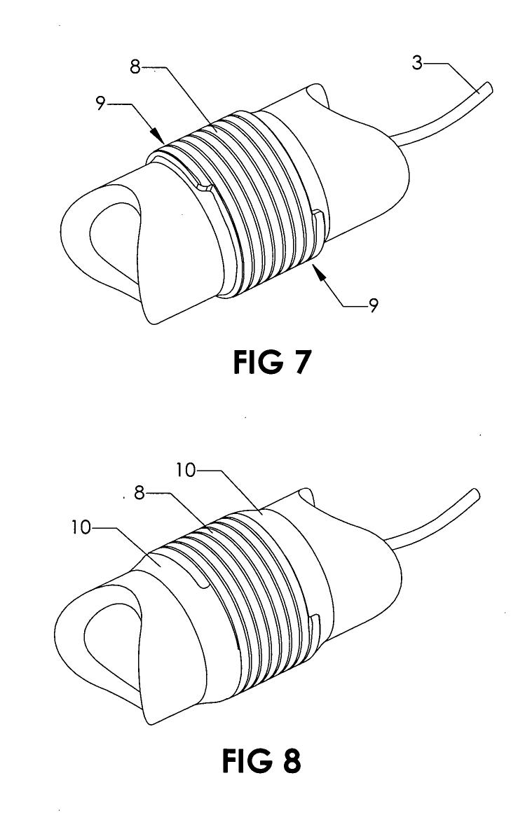

8. FIG. 7 shows the windings of the coil being joined together into a solid ring 8 by means of a thick layer of electro-plated material. FIG. 7 also shows the shallow troughs 9, arranged in a helical pattern, after the gaps between the windings are bridged across with plating material. The use of electro-plating is recommended because this method of material deposition can be done at a temperature that the plastic nature of the tubular body will tolerate. Furthermore, this method allows a uniform build up of plating material to enough height where the bridging between the windings can occur. Any conventional plating bath can be used, but copper and nickel baths are preferred because they are readily available, inexpensive and easy to handle. The formulas to prepare plating solutions for copper or nickel can be easily found in literatures from the public domain such as the book of Modern Electroplating (edited by Lowenheim, page 186 or pages 214-215). These solutions can also be easily purchased directly from suppliers such as Rosenthal Jewelers Supply (Cat No. P101 and P102).
For a uniform build-up of the layer of plating material 8 over the surface of the shaved off coil 7 from FIG. 6, it is necessary to design a plating bath (not shown here) with the anode in the shape of a cylinder. In this design, coil 7 in FIG. 6 is connected to the positive terminal of the power supply via the conductor lead 3 at the far end. As a cathode, coil 7 must be placed at the center and along the axis of the anodic cylinder. Under such a configuration, the distance between the surfaces of the two electrodes is relatively constant, and the rate of material build-up is about the same at any point on the surface of the cathode. The resulting solid ring 8 has a fairly uniform wall-thickness. The optimum dimension of the anodic cylinder is about 10 cm in inside diameter. The height of the cylinder as well as the column of plating solution should be tall enough to completely submerge all the coils that need to be plated at the same time.

9. FIG. 8 shows the edges of the solid ring 8 filled with epoxy 10. This filling epoxy 10 is our chosen method to give the ring a smooth profile for maximum patient-comfort during the insertion of the device into the patient tubular organ. Again, any type of filling epoxy can be used here, but photo-curable epoxy is recommended for ease of use and fast curing result. It is important to note that this step of epoxy filling can be postponed or even skipped without any consequence to the fabrication process or performance of the ring.

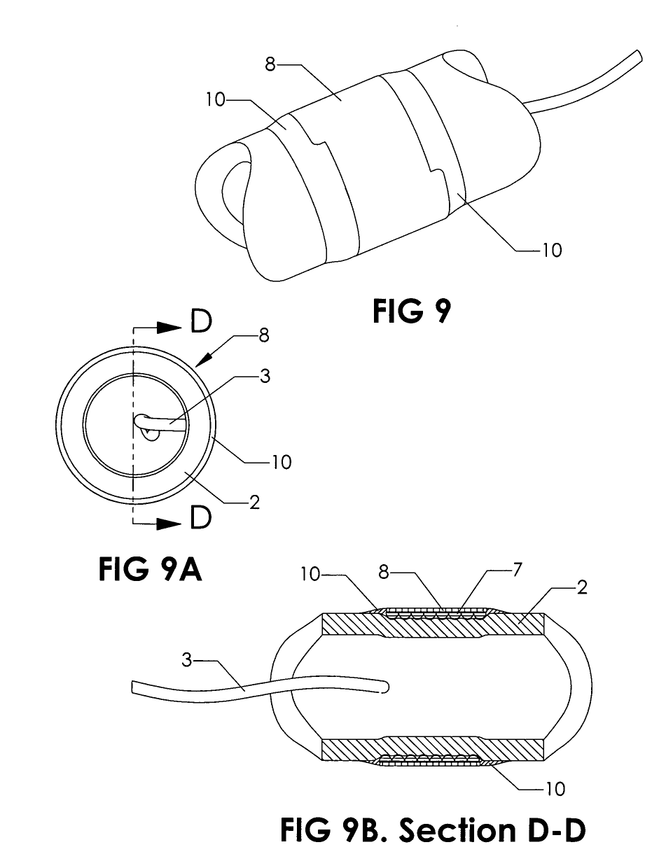

10. FIG. 9 shows a view of the final shape of the solid ring 8, with a smooth surface after the excess of plating material has been removed. Removal of the plating material in this step must only be done with the mechanical methods listed in paragraph 7 above. The reason for only the method of mechanical removal can be used is that epoxy 10 on both ends of the ring 8 needs to be removed at the same time as the excess plating material. Polishing is necessary to give the surface a bright finish and can be done with ultra-fine sanding papers or motorized rubber wheels. At this stage, if the plated material such as copper needs to be protected from corrosion, a final layer of a few microns thick of nickel, silver, gold, or platinum can be applied over the surface of the ring by means of any conventional material deposition technique. For most applications, immersing the copper rings for a few minutes into a tin plating solution (Sullivan and Pavlish, U.S. Pat. No. 2,369,620) is enough to protect the surface of the ring from oxidation over a long period.

11. FIG. 9A is the view along the axis of the tubular body showing the low profile of the solid ring 8 and the short height of the filling epoxy 10. It also shows the absence of any contact junction required by the conductor lead 3, and the optimum space preserved inside of the tubular body 2.

12. FIG. 9B reveals the internal structure of the ring made with the method of the disclosure, with the solid ring 8 in the shape of a cylindrical shell built up from a layer of electro-plated material, in firm electrical contact with the shaved coil 7. The whole assembly of ring 8 and shaved coil 7 is flush-mounted on top of tubular body 2 while being directly connected to conductor lead 3 without the need for any junction attachment.

1. A method to mount electro-conductive rings onto a tubular non-conductive body, comprising the steps of.
Wrapping one end of a conductor lead around the tubular body into a coil
Securing both ends of each coil with epoxy
Leveling the outer surface of the coil to reduce the depth of the gaps between the windings of the coil
Plating over the outer surface of the coil with enough material to bridge across the gaps between the windings, turning the coil into a solid ring.
Filling both ends of the ring with epoxy to create a smooth profile
Grinding and polishing the outside of the ring to obtain a smooth surface finish

2. A method according to claim 1, wherein the said coil is composed of a series of tightly packed windings.

3. A method according to claim 2, wherein the said tightly packed windings provides a platform for the said ring.

4. A method according to claim 2, wherein the tightly packed windings are joined together into a solid ring, by means any conventional electro-plating technique.

5. A method according to claim 2, wherein conductor lead can be bare or coated with a non-conductive material.

6. A method according to claim 3 wherein said the number of said windings can be 1 or several, depending on the desired length of the said ring.

7. A method according to claim 1, wherein conductor lead is a single-strand wire made from soft-temper metal suitable for electro-plating such as copper, silver, nickel or gold.

8. A method according to claim 1, wherein said a non-conductive tubular body can be of any kind of flexible plastic material, having one or several lumen along its length.

9. A method according to claim 1, wherein more than one said ring can be mounted on the same said tubular body by using the same technique, with one conductor lead per ring.

10. A method according to claim 1, wherein the said leveling involves the use of any sanding, grinding, filing, cutting, etching, polishing, chemical etching or electrochemical stripping tools and techniques, to remove material from the surface of the said coil.

11. A method according to claim 1, wherein the said plating involves the use of any conventional electroplating bath made with salts of the same metal as that of the said conductor lead.

12. A method according to claim 1, wherein the said plating involves the use of any conventional electroplating bath made with salts of a different metal than that of the said conductor lead.

13. A method according to claim 1, wherein the said ring can have an optional final coating of corrosion-resisting metal such as tin, nickel, silver, gold or platinum, to protect its surface finish.

14. A method according to claim 13, wherein the said ring can be used as a contact platform for other MEMS devices (Micro Electro-Mechanical Sensors) to be connected.

15. A method according to claim 1, wherein the said ring can have an optional final coating of:
a metal such as tin, nickel, silver, gold or platinum.
a salt of a metal such as silver chloride or silver iodide.
an oxide of a metal such as antimony oxide or iridium oxide.

16. A method according to claim 15, wherein the said ring can be used as a cylindrical electrode for bio-signal sensing or recording.

17. A method according to claim 1, wherein the said ring can have an optional final coating of:
a metal such as platinum.
a salt of a metal such as silver chloride or silver iodide.

18. A method according to claim 17, wherein the said ring can be used as a cylindrical electrode for electrical stimulation.
